(19) United States
(12) Patent Application Publication
(10) Pub. No.: US 2008/0075874 A1
(43) Pub. Date: Mar. 27, 2008

(54) Process for treating wood and products from treated wood

(76) Inventor: Darrell W. Kelsoe, Newark, NJ (US)

Correspondence Address: J. WILEY HORTON, ESQUIRE;Pennington, Moore, Wilkinson, Bell & Dunbar, P.A., Post Office Box 10095, Tallahassee, FL, 32302-2095, US

(21) Appl. No.: 11/525,597

(22) Filed: Sep. 22, 2006

Related U.S. Application Data
(63) Continuation-in-part of application No. 09/885,642, filed on Jun. 20, 2001, now abandoned.

(51) Int. Cl. B27K 3/52

(52) U.S. Cl. 427/397

(57) ABSTRACT

A chemical composition that has been specifically created for use in treating wood and wood products. The composition preferably comprises non-toxic and environmentally safe components which react with molecules of the wood. When the composition comes in contact with the wood, a reaction occurs which causes a molecular change in the wood itself. This molecular change improves the wood's strength and durability while simultaneously rendering the wood impervious to water, fire, rot, fungus, insects and many other potentially damaging environmental conditions.

### CROSS-REFERENCES TO RELATED APPLICATIONS

This application is a continuation-in-part of U.S. application Ser. No. 09/885,642 to Darrell Kelsoe, which was filed on 20 Jun. 2001. The entire disclosure of U.S. application Ser. No. 09/885,642 is hereby incorporated by reference.

### STATEMENT REGARDING FEDERALLY SPONSORED RESEARCH OR DEVELOPMENT

Not Applicable.

### MICROFICHE APPENDIX

Not Applicable

### BACKGROUND OF THE INVENTION

1. Field of the Invention

This invention relates to the field of wood treatments. More specifically, the invention comprises a process of treating wood and products from treated wood.

2. Description of the Related Art

The prior art consists of various chemical and dry kiln loading and unloading techniques for wood. Silicon treatments are not unknown, but actual modification of the cellulose to incorporate a silicon shield is unknown.

Scientists and researchers have been seeking an effective silicon based wood treatment for decades. Studies have suggested that silicon is effective in the treatment of wood. Difficulties have arisen, however, in how to effectively carry the silicon into the wood and keep it there. Studies performed by leading researchers in the United States and Europe have noted that the water repelling effects of silicon are often outweighed by the swelling of the wood.

In addition to the benefits of silicon are the well documented benefits of boron. Boron compounds are well known insect repellents and they are widely used in the treatment of wood products, primarily oriented strand boards (OSB) and other manufactured wood products (including those that are used in residential construction). The biggest drawback of the use of boron in the treatment of wood is that it leeches out of the wood too quickly. This leeching has the obvious detrimental effect of leaving the treated wood in a un-treated state after a relatively short period of time.

Current wood treating techniques require that the wood be dried prior to the treatment process. Carriers are then used to deliver the chemical treatment to the wood. If the wood is naturally “wet” (or green) the carrier is less efficiently absorbed and cannot effectively distribute the treatment chemical. Cut timber needs to be dried to a level of approximately 14-20% moisture prior to treatment with existing chemical formulations. A “green” piece of wood will not allow a prior art treatment carrier to enter to an acceptable level. It is somewhat akin to a wet sponge. When it is very wet, it will not absorb any more moisture. It needs to be dried to a certain degree to allow more liquid to penetrate its surface.

Wood is currently dried in one of several, expensive ways. Larger wood pieces (i.e. railroad ties, utility poles, timbers, etc.) are typically “air dried.” This process requires that the wood be stored in vast lots where the wood will naturally dry due to its exposure to the elements. In addition to the costly management, there is the hidden cost of inventory. Most wood that is air dried is required to sit idle on a lot for 6 to 12 months. The financial burden of having to carry these enormous inventories of dormant wood has been estimated at nearly $100 million annually for the railroad industry alone.

The other common drying technique is kiln drying. This is a significantly faster process but the expense involved in the construction of the drying buildings and the energy utilized to heat the wood can be as expensive as air drying. Accordingly it would be advantageous to provide a wood treatment solution which does not require drying of the wood.

Existing wood treatment methods require that a chemical be carried into the wood to create the desired results. The treatment methods most commonly used today utilize oil (in the case of creosote) or water (in the case of Chromated Copper Arsenate) as the carrier to deliver the treatment chemicals into the wood. These carriers are used to force chemicals inside of the wood to treat the wood. There is no appreciable chemical action or reaction with the wood itself. Any such reaction is incidental.

Several factors can result in differing levels of benefit to the treated wood using current methods, including (1) the amount of the chemical in relation to the carrier (i.e. the dilution of the mixture); (2) the amount of pressure exerted on the chemicals to “force” the chemicals into the wood; and (3) the amount of time the wood remains under pressure.

These primary variables can be adjusted to produce different “grades” of treated wood for different end products. For example, a piece of dimensional lumber will not normally be as thoroughly treated as a pole that will be submerged under water. A railroad cross tie which will be in direct contact with the ground can be “treated” more than wood used in common decking. Typically, high concentrations of chemicals relative to carriers and longer treatment times result in higher overall costs of treatment.

There are disadvantages to using water and oil carriers. While these carriers may be effective at carrying the chemical into the wood, the carriers themselves are also brought into the wood, and often remain in the wood themselves. A standard cubic foot of untreated wood will absorb as much as 3.5 gallons of water or oil during a normal treatment process. Regardless of how much treating chemical is carried into the wood, some oil or water also remains in the wood, adding weight without providing a corresponding treatment benefit. The remaining oil and water may even serve to carry out some of the treatment. Accordingly, it would be desirable to provide a more advantageous carrier.

### BRIEF SUMMARY OF THE INVENTION

The Wet Preservation Chemical Treatment (hereinafter “WPTC”) is a chemical composition that has been specifically created for use in treating wood and wood products. The composition preferably comprises non-toxic and environmentally safe components which react with molecules of the wood. When the composition comes in contact with the wood, a reaction occurs which causes a molecular change in the wood itself. This molecular change improves the wood's strength and durability while simultaneously rendering the wood impervious to water, fire, rot, fungus, insects and many other potentially damaging environmental conditions.

In the preferred embodiment, the proposed composition contains silicon and boron. These two chemicals have been proven effective in the treatment of wood and wood products. The proposed composition solves the problems associated with the prior art and prevents the chemicals from leeching out of the wood subsequently. Using the proposed composition, at least one of the chemicals are absorbed into and become part of the wood. Chemical equivalents may also be used.

The “carrier” used in the proposed composition works with the molecules of the wood. The proposed composition is not “forced” into the wood, but is drawn into the wood by reactions occurring between the proposed composition and the molecules of the wood. The composition reacts with the molecules of the wood to force an expulsion of the water and other liquids inside the wood while reacting to form a tough, highly resistant polymer shield. Because the composition is naturally drawn into the wood, there is no need to pressurize the wood during treatment.

Because the proposed formulation is drawn into the wood through a molecular reaction, it actually works faster on a “green” piece of wood. This is due to the fact that the chemical reaction is accelerated by the mixture of the proposed formulation with water and other natural liquids inside a piece of wood. The reaction draws the treatment chemicals into the wood and causes a molecular reaction which expels excess water and other liquids originally contained in the wood. As such, the proposed treatment treats and dries the wood in one step.

When the reaction is complete, water and other liquids are less able to enter the wood. Tests show that wood treated with the proposed formulation of the preferred embodiment are waterproof, decay resistant, insect resistant, and stronger. The results is a wood product that is nearly “petrified” in its defense against water, rot, insects and other ailments common to wood. Water “beads” on top of wood treated with WPTC due to the polymer shield created by the chemical reactions. Rot is hindered since it requires moisture to thrive. Insects and fungus cannot thrive because of the lack of moisture, the presence of boron compounds, and their inability to penetrate the polymer shield.

While current treatment processes require an additional chemical and treatment process to provide a minimal level of fire retardant, the proposed formulation can be enhanced to produce a wood with fire-retardant properties. This enhancement does not require any additional conventional equipment and can be completed as part of the chemical process.

WPTC treats the wood without altering the shape of the wood or causing the wood to swell. The proposed formulation may also be employed as an after-market treatment product. The after-market product will be slightly different than the commercial product, typically in its level of strength. This is significant, because many existing structures and wood products can still be benefited by a treatment with WPTC. Anticipated after-market examples include treating of wood frame houses to control termite and/other bug infestation; the treatment of previously installed railroad ties, utility poles, and decking.

### BRIEF DESCRIPTION OF THE SEVERAL VIEWS OF THE DRAWINGS

FIGS. 1A, 1B, and 1C are alternate views of the structure of the cellulose of wood.

FIG. 2 is a view of a chemical process for altering the cellulose structure of wood showing the alteration of the structure of a single strand of cellulose.

FIG. 3 shows a generic representation of the formula shown in FIG. 2.

FIG. 4 shows one alternate structural cellulose target.

FIG. 5 shows an alternative target for the structure of treated wood.

FIG. 6a shows one theoretical model for products by the process taught herein.

FIG. 6b shows an alternate theoretical model for product generated by the process taught herein.

FIG. 6c shows a representation of cellulose.

FIGS. 7A, 7B, and 7C illustrate the reaction of wood cellulose with a silicon donor.

FIGS. 8A, 8B, 8C, and 8D illustrate an alternate embodiment of the invention. FIGS. 8B1 and 8B2 show alternate intermediary boron molecules which may be generated in the process.

FIG. 9 shows an alternate mechanism for achieving an alternative to intermediary 8B.

FIG. 10 shows the production of an intermediary and a possible reaction using both boron and silicon to guarantee a polymer with silicon and boron in the modified cellulose structure.

FIG. 11 illustrates a reaction with a reagent with cellulose.

FIG. 12 shows a similar reaction to that shown in FIG. 11 with a boron molecule substituted for the silicon molecule.

FIGS. 13A, 13B, and 13C, illustrate of a process to treat wood.

FIG. 14 shows a block diagram of a process to form particle board.

FIG. 15 shows the process utilizing a catalyst.

FIG. 16 shows an alternate embodiment of the process where the catalyst is an acid. FIGS. 17A, 17B, 17C, 17D, and 17E show a view of the wood as it's exposed to a catalytic and non-catalytic reactant of the type taught herein.

FIGS. 18, 19, 20, and 21 show test results of wood exposed to the chemical process taught herein.

### DETAILED DESCRIPTION OF THE INVENTION

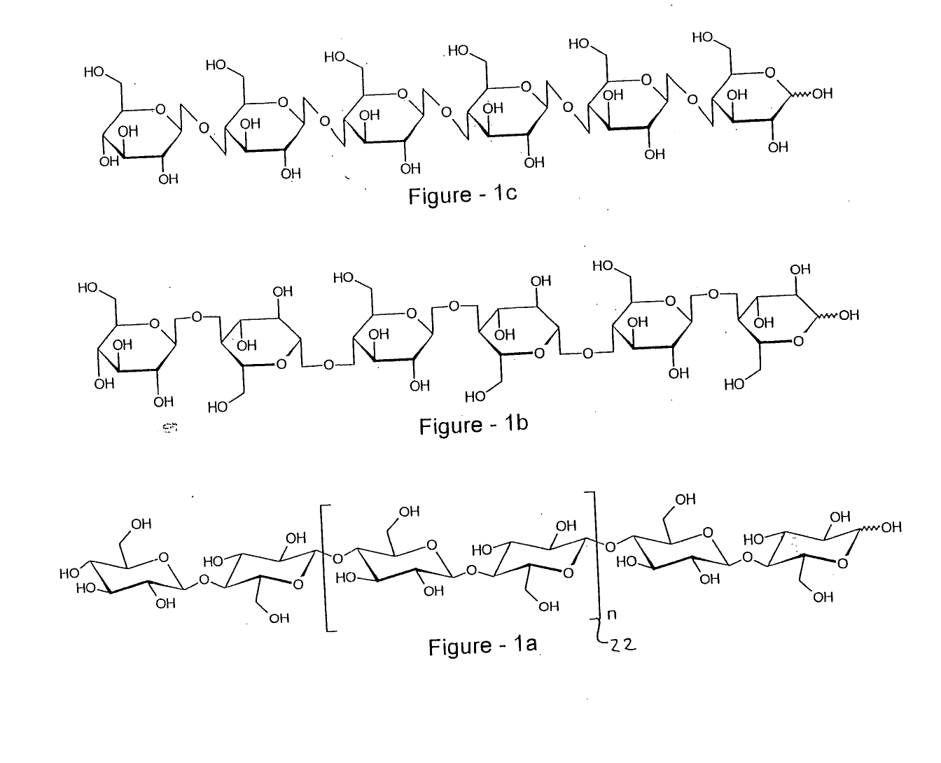

The present invention relates to the treatment of wood in such a way that the chemical structure of all or part of the cellulose is altered to preserve the wood. Cellulose is one of the primary ingredients of wood. It maybe described as a chain of linked glucose units. As illustrated in FIGS. 1A, 1B, and 1C, wood cellulose can be drawn as repeating series (n) of cellulose units 22 having hydroxyl groups. FIGS. 1A, 1B, and 1C show the generally accepted ways of drawing the same structure in slightly different formats.

Broadly, the invention can be described as the treatment of wood with a reactive silicate donor which replaces some of the molecules or atoms within the cellulose structure with silicon. In the preferred embodiment, the invention accomplishes this by modifying the hydroxyl groups of cellulose. In the preferred embodiment, the reaction is catalyzed by using an acid or by creating an acid during a reaction with the cellulose or water within the wood with a pro-catalyst.

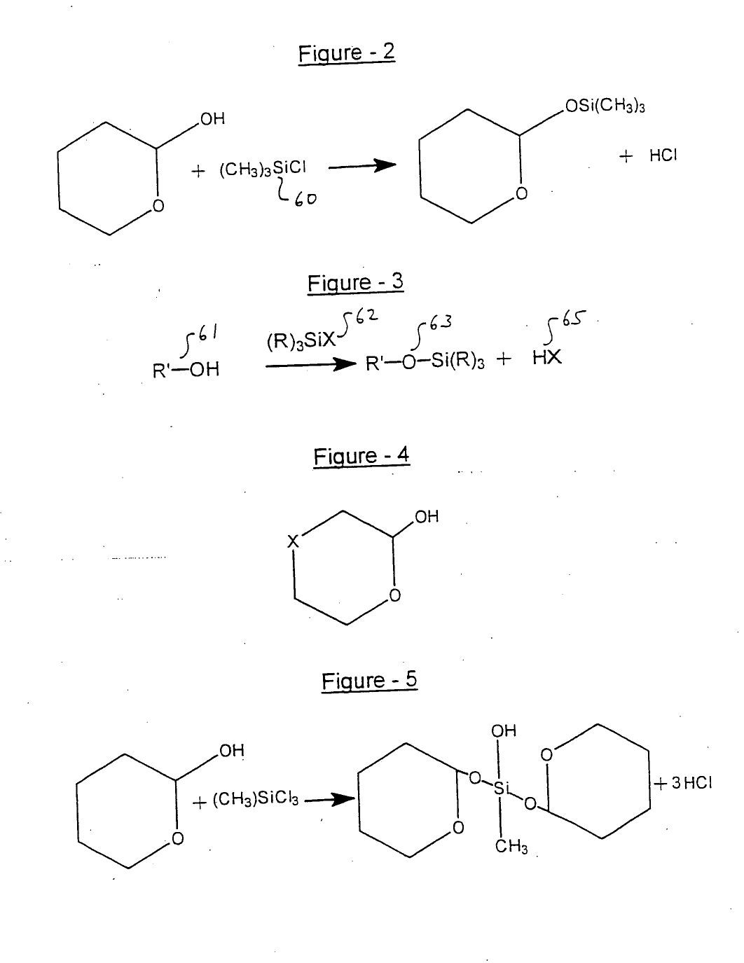

As illustrated in FIG. 2, one method of modifying the structure of the wood would be to introduce tri-methyl chloro silane [(CH₃)₃SiCl] 60 to the cellulose molecule to create a modified cellulose. In the modified cellulose, carbon silicate replaces the hydroxyl group. The reaction also creates an acid which can further catalyze the reaction as discussed in greater detail subsequently.

As illustrated in FIG. 3, alkyl hydroxyl molecule 61 is reacted with tri-alkyl halide silicate 62 in the presence of water from wood to yield modified molecule 63 and acid 65. Modified molecule 63 is more hydrophobic than hydroxyl molecule 61. Acid 65 thereafter acts as a catalyst to continue the reaction as described in greater detail subsequently.

In more violent reactions, silicone or other reactants may be found in other locations in the wood as shown in FIGS. 4 and 5. It should be noted that these are more extreme examples of potential byproducts of the reaction illustrated in FIG. 3 and are theoretically unlikely to occur within the framework described herein.

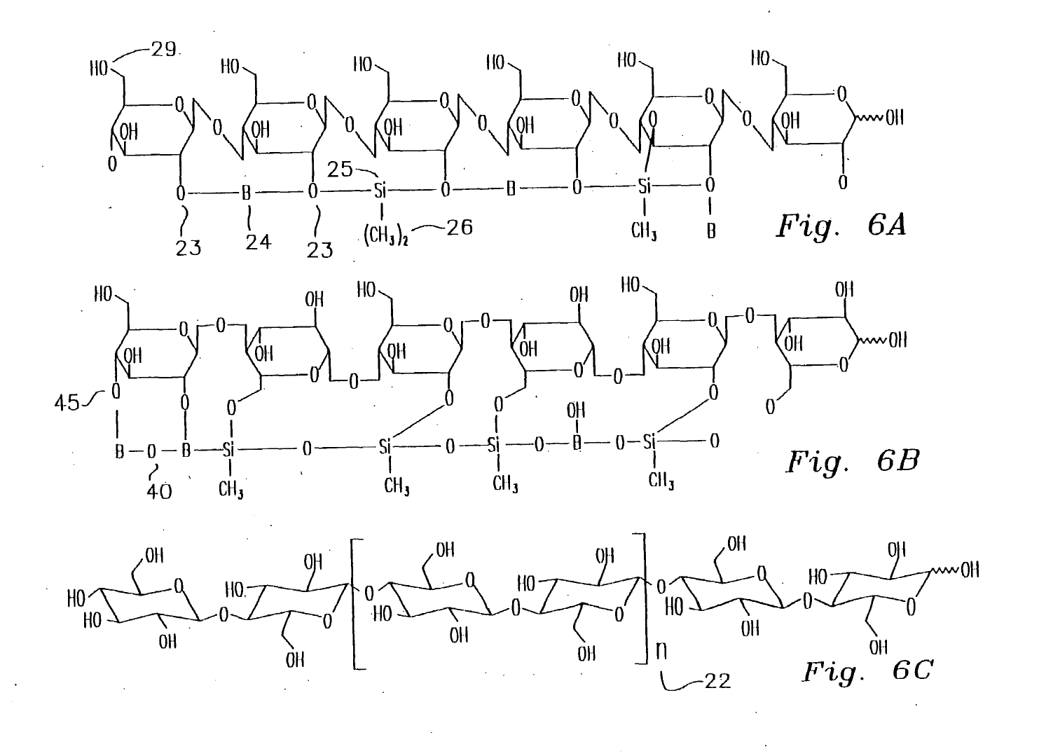

FIG. 6A shows one possible structure for a modified cellulose molecule. This molecule may be produced by exposing wood cellulose to silicon and boron reactant molecules and solutions taught herein. This molecule contains a limited replacement of the hydroxyl groups with boron and silicon. Although FIG. 6A shows one possible structure for a modified cellulose, it should be noted that it is not the most likely structure to be produced by the process taught herein. The reader will note that in this modified cellulose chains, boron atoms 24, silicon atoms 25 or other hydrophobic or anti-degrading elements are bonded between hydroxyl oxygen atoms 23. As illustrated in FIG. 6A, silicon atoms 25 preferably have alkyl groups 26 attached thereto to form alkyl silicates. These alkyl groups may be varied in accordance with the following disclosure or may be replaced altogether.

The most likely product of the process is illustrated in FIG. 6B. The expected end product contains boron atoms and alkyl silicates which bind across the hydroxyl groups of the cellulose rings. Oxygen molecules 40 share electrons with the boron atoms and alkyl silicate molecules to complete the outer valence shells. As illustrated in FIG. 6B, the bonding is more likely to be less organized than that suggested in FIG. 6A. As illustrated in FIG. 6B there may be bonding across more than one hydroxyl group in a single cellulose molecule within a chain of repeating units (shown again in FIG. 6C as n repeating cellulose units 22). The exact alignment can vary and may be different according to the reactants used. One key fortune of the invention shown in these Figures is the ability of this process to allow for proper alignment of individual reactant monomers and trivalent, tetravalent and pentavalent atoms withing the reactants to bond with the wood cellulose structure.

A molecule which can undergo polymerization, thereby contributing constitutional units (the single trivalent, pentavalent and tetravalent atom constitutional units (e.g. MeCl₃Si-methyltrichlorosilane)) in this invention can be referred to as contributing constitutional units or functional units or functional groups of the polymer or oligomer (e.g. the cyclic Silanes as described formed after the functional groups are reacted within the wood) to the essential structure of a macromolecule is a monomer. An oligomer is molecule of intermediate relative molecular mass, the structure of which essentially comprises a small plurality of units derived, actually or conceptually, from molecules of lower relative molecular mass, i.e. the monomers described herein. Similarly, the polymer definition of a molecule of high relative molecular mass, the structure of which essentially comprises the multiple repetition of units derived, actually or conceptually, from molecules of low relative molecular mass, i.e. the monomers herein described as coming from independent trivalent, tetravalent or pentavalent atoms bonded to the disclosed functional groups or their equivalents.

Also relevant is the polymer properties that in many cases, especially for synthetic polymers, a molecule can be regarded as having a high relative molecular mass if the addition or removal of one or a few of the units has a negligible effect on the molecular properties. This statement fails in the case of certain macromolecules for which the properties may be critically dependent on fine details of the molecular structure. If a part or the whole of the molecule has a high relative molecular mass and essentially comprises the multiple repetition of units derived, actually or conceptually, from molecules of low relative molecular mass, it may be described as either macromolecular or polymeric, or by polymer used adjectivally.

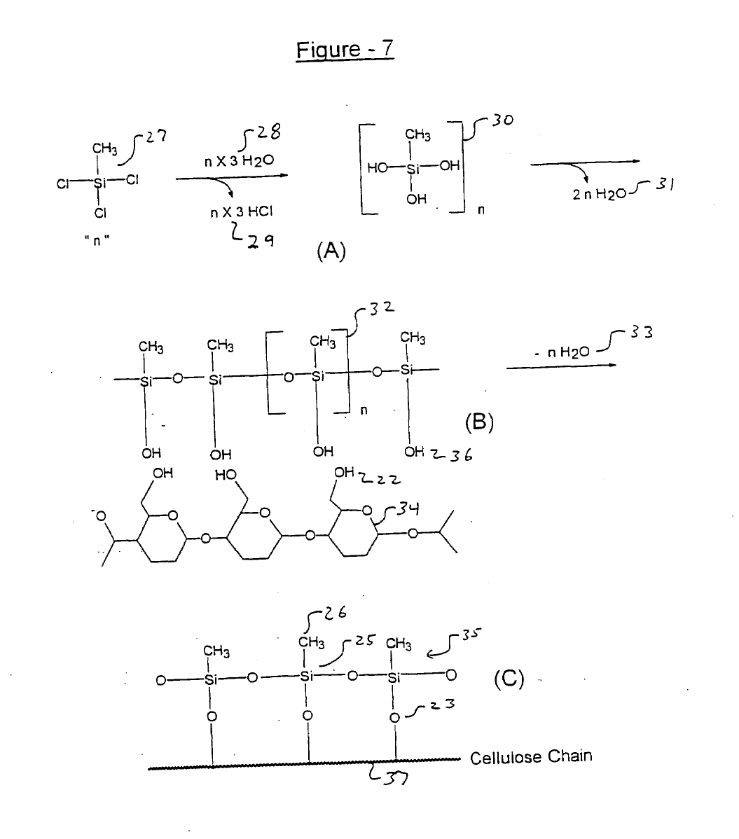

FIG. 7 shows the suspected mechanism for producing a modified cellulose chain using the proposed method. Methyl trichloro silane 27 is used as a reactant or catalyst. There are “n” molecules of the catalyst which react with “n” molecules of H₂O present in the wood to yield “n” times 3 HCl molecules 29. HCl molecules 29 provide an acidic environment for catalyzing the reaction of the silicate with the hydroxyl group. This reaction draws the reactants into the wood and allows for a greater penetration of the treatment into the wood. The silicate is converted to hydroxyl form 30 (postulated) which finally formulate as a chain of silicate units 32. Hydroxyl units 36 along the chain of silicate units then react with hydroxyl units 22 of cellulose ring units 34. The chain of silicate units 35 is thereafter bonded to cellulose chain 37 across oxygen atom 23.

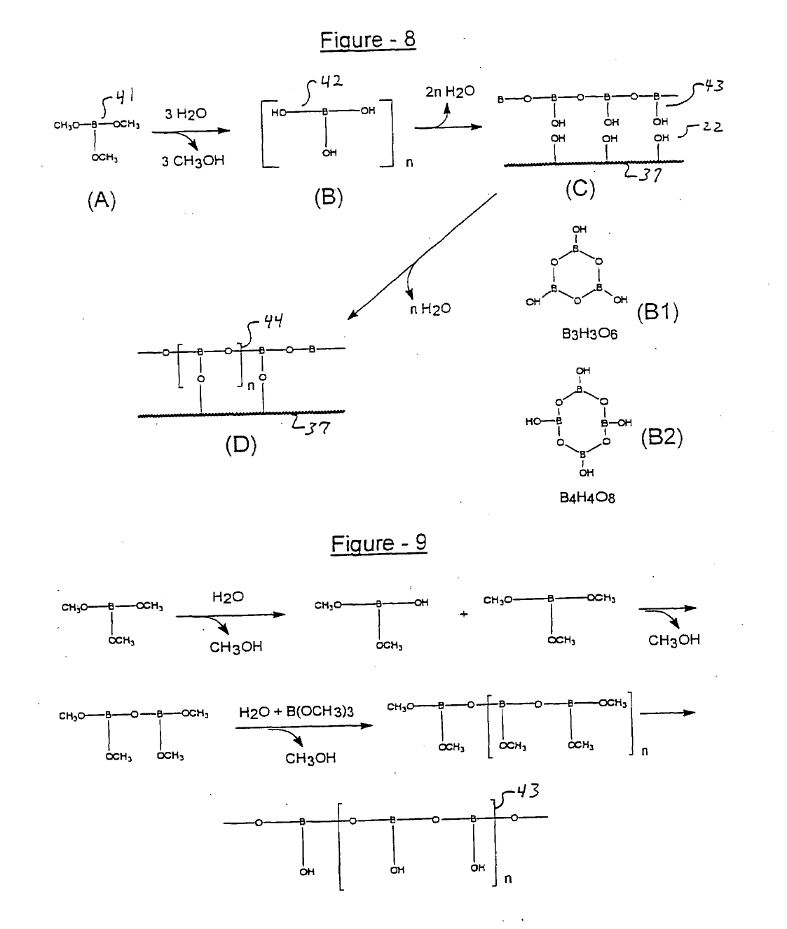

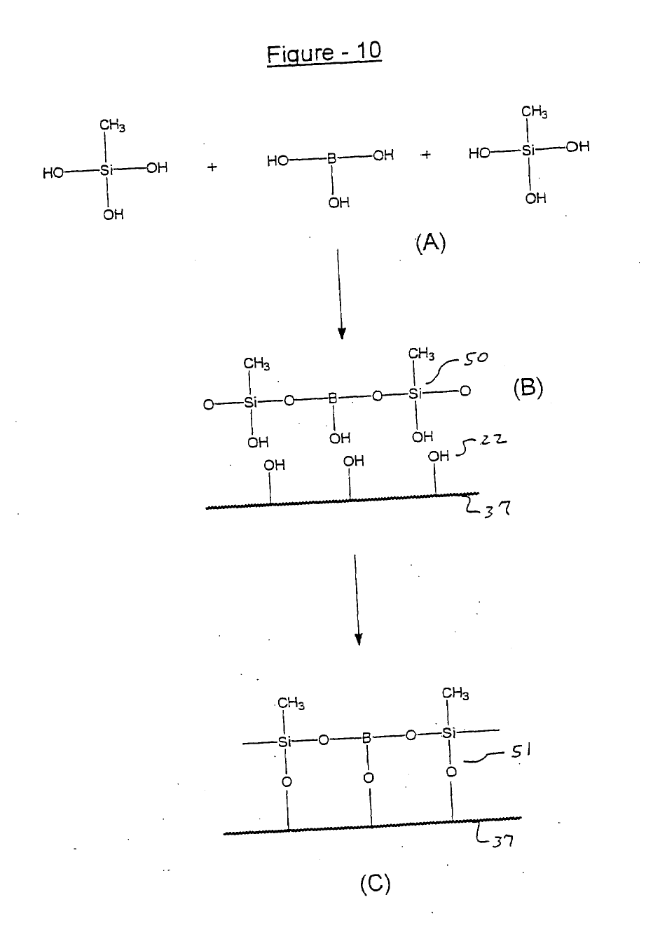

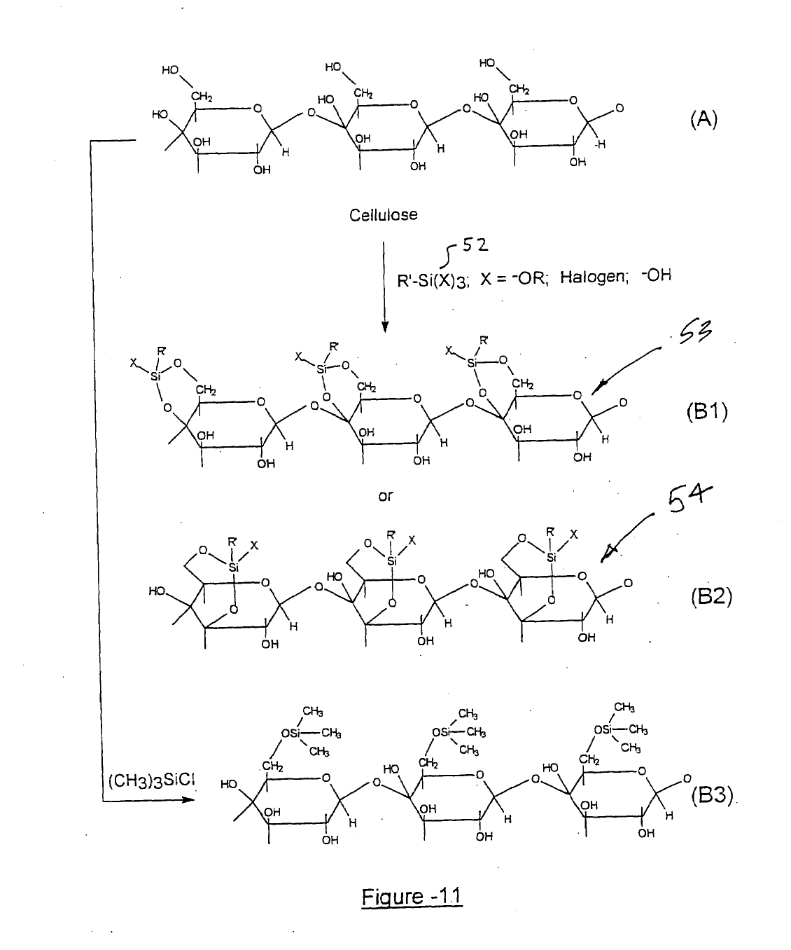

FIG. 8 shows how boron may be introduce and “trapped” within a matrix using the preferred embodiment. The trapping of boron is particularly helpful since it provides additional insect resistance to the end product. In FIG. 8 it can be seen that boron compound 41 in the presence of water (from the wood) forms boron hydroxyl molecule 42. Boron hydroxyl molecule 42 polymerizes much as the silicate in FIG. 7 to form boron hydroxyl chain 43. In the presence of cellulose chain 37, chains 44 are formed in the cellulose matrix. Alternative molecules shown as B1 and B2 may be formed as intermediary of final products. These alternative molecules may also become trapped in the matrix formed by the boron compounds. They may also become trapped in the matrix formed by silicates shown in FIG. 7 where boron and silicon products are used together. That is, since water cannot get through, the atoms of free borates (borates not forming a part of the matrix) and other additives are effectively trapped within the wood by this treatment. FIG. 9 shows an alternate mechanism for the formulation of boron chains 43.

The process works effectively in the presence of hydrochloric acid or other acid having a pKa of less than 2.5. Boric acid, for example, which may form as in intermediary, would not drive the reaction shown in FIG. 8. The use of pro-catalysts is described later herein, but it may be seen by reference to FIG. 7 where the tri-chlorosilane, as pro-catalyst, yields 3 HCl which acid would drive the reaction. The acid may or may not be referred to as a catalyst. This is also true of the reaction shown in FIGS. 9 and 10 where the trichlorosilane drives the reaction through the production of hydrochloric acid during the solvation of the reactants. While a pKa below 2.5 is preferred, the reaction can be driven by an acid catalyst with a pKa for acid catalysts below 4.00 and pKb for base catalysts above 9.00

FIG. 10 shows Si(OH)₃CH₃ and B(OH)₃ from the solvent drawn into and reacted with the wood cellulose using a catalyst which is introduced into the wood as a pro-catalyst (FIG. 7) or otherwise. One other way would be to inject a solution with a weak acid concentration (0.1%-0.5%) of strong acid into the wood, but this would be different from the simple transport of reactants where the reactants (trivalent, tetravalent, and pentavalent atoms with an alkoxy component or as pro-catalyst with a halogen component) are drawn from the organic solvent into the wood down concentration gradients and which react exothermically.

FIG. 10 shows a mechanism for the combination of silicates and boron molecules to form intermediary chains 50. Intermediary chains 50 comprise both silicon and boron atoms. In proximity to cellulose chain 37, intermediary chain 50 reacts to form modified combination molecules 51 (which are the same as shown in FIG. 6b).

FIG. 11 shows an alternate mechanism for the combination of silicon reagents with cellulose. In FIG. 11, R′—Si(X)₃ 52 is placed in proximity to cellulose, such as by way of a carrier solution as will be described in greater detail subsequently. R′ is an alkyl or an alkyl equivalent and X is an OR group (R being an alkyl group from the same generic group as R′) or a halogen, or a hydroxyl group (OH). The reaction s may also yield intermediary 53 or 54 or both intermediaries 53 and 54. In the presence of an acid, these intermediaries yield a more complex molecule where the silicate is combined along the carbon atoms of the cellulose as opposed to the hydroxyl groups as shown at B3.

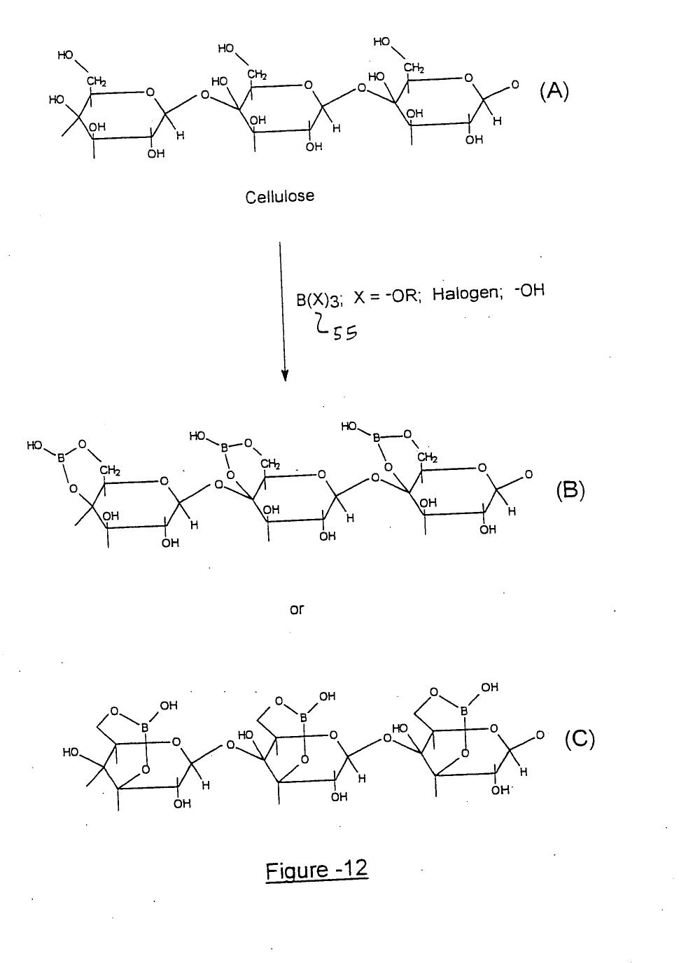

FIG. 12 shows an embodiment where boron compounds 55 are substituted for the silicates in the reaction illustrated in FIG. 11 to yield the end products shown in steps B and C of FIG. 12.

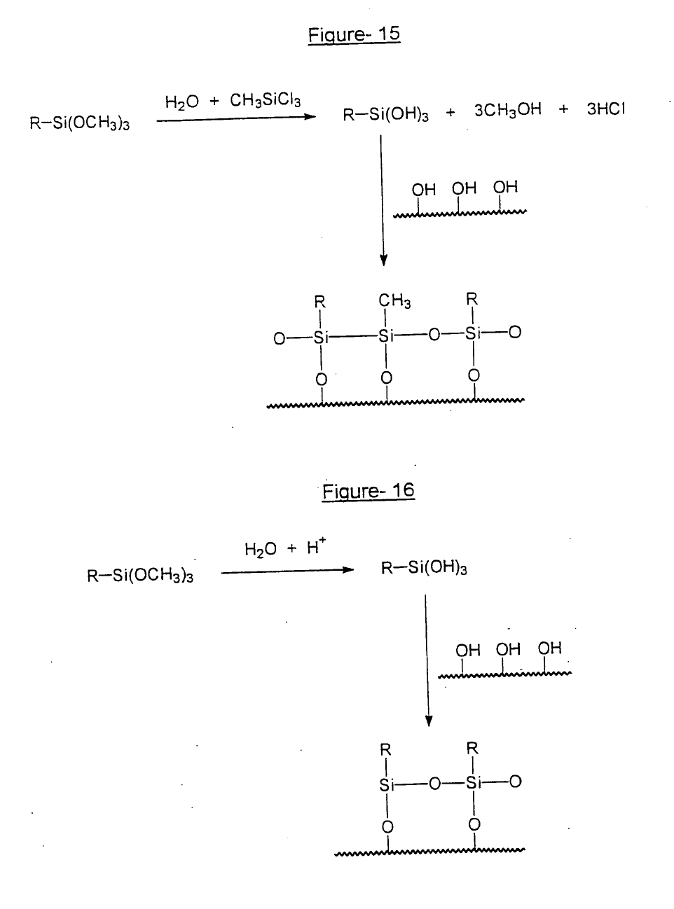

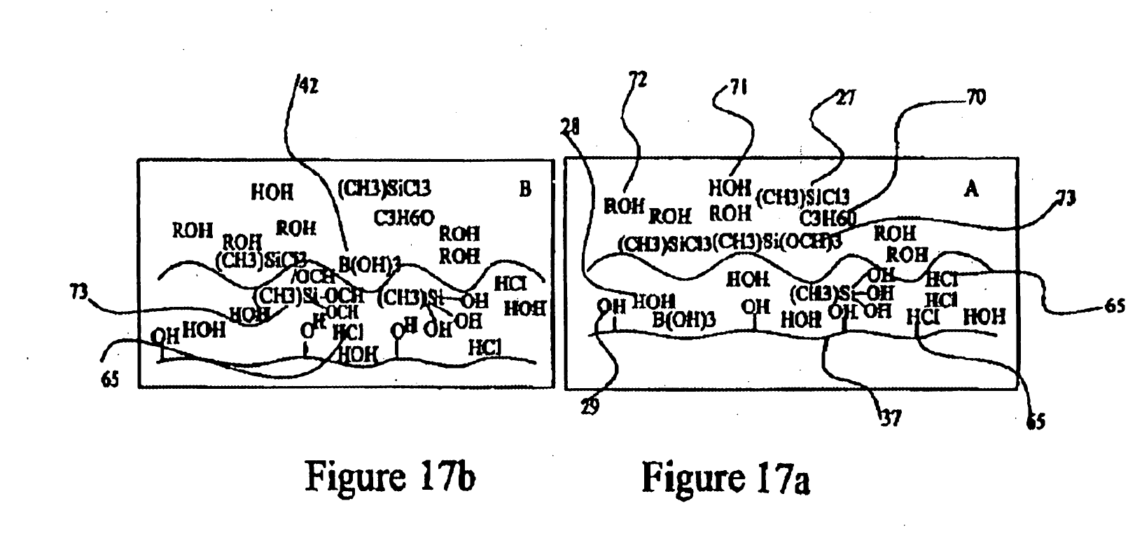

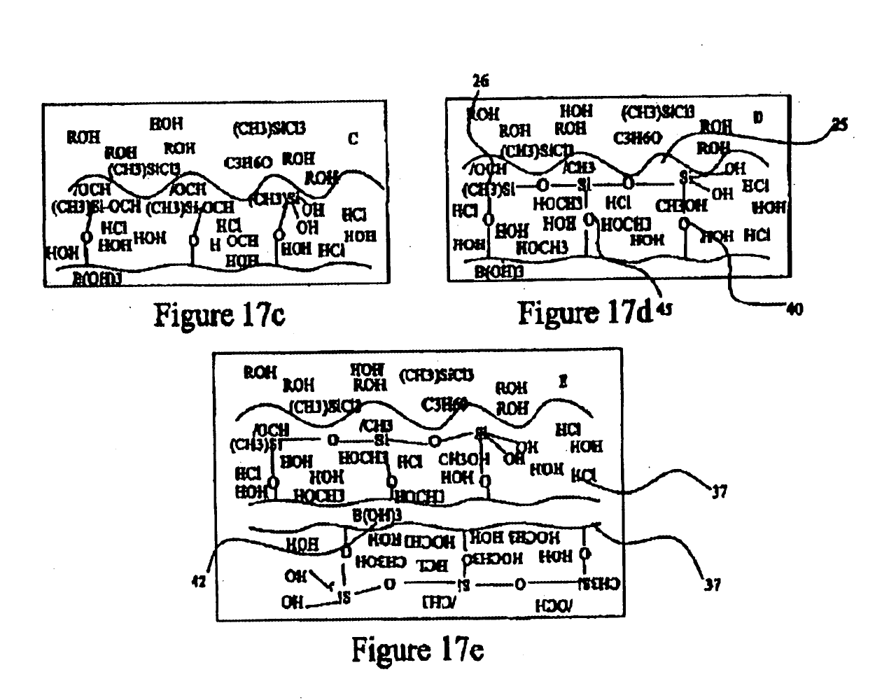

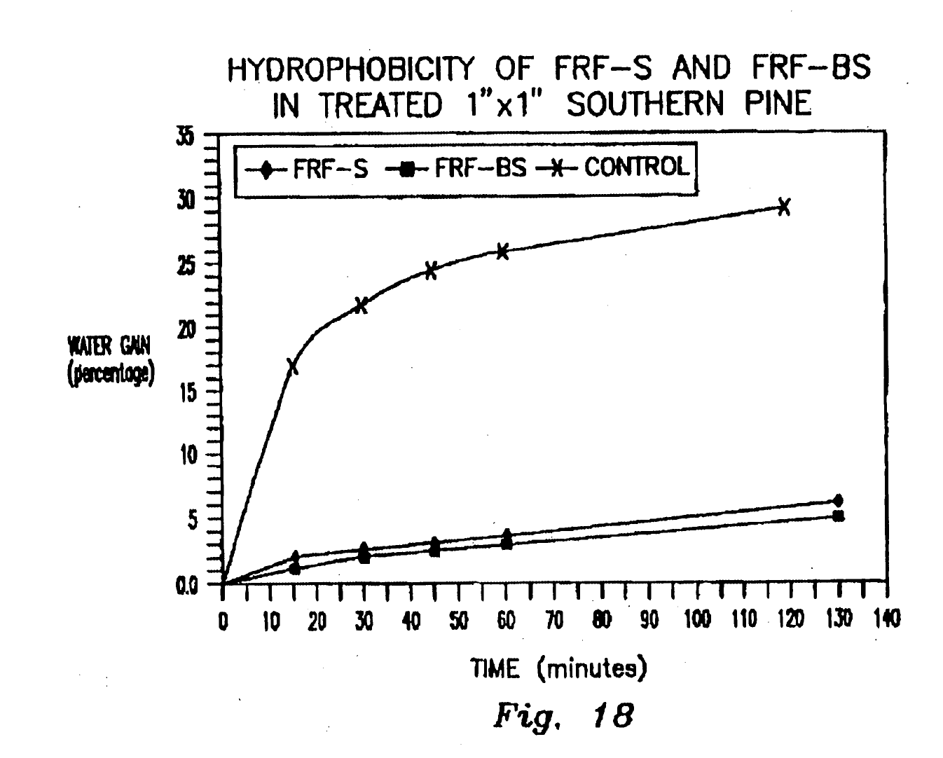

In order to allow for use of more common reactants, acids or acid-yielding molecules may be used as a catalyst for the reaction as illustrated in FIGS. 15 and 16. In this embodiment, the process includes the steps of: (1) preparing a solution, preferably in an alcohol; (2) adding a silicon donor, such as a one to eight carbon alkyloxy group; (3) adding a strong acid (hydrochloric, phosphoric, or sulfuric acid) directly or by way of a pro-catalyst yielding the acid in solution with water in the wood, such as methyl tricholor silane (CH₃SiCl₃). In the preferred embodiment, this is preferably an acid solution of 0.5%, but may range from 5% to 0.1%. Wood cellulose is then exposed to the solution prepared in steps 1-3 to allow binding as previously described.

When in contact with the water in the wood, the acid yields ROH and RSi(OH)₃ compounds. The RSi(OH)₃ react with the cellulose as described previously to bond to the cellulose chain in place of one or more of the hydroxyl groups of the cellulose to form a hydrophobic barrier. Alternatively, the protonated silicon donor (protonation by acid generated in situ with the pro-catalyst) reacts directly with the hydroxyl groups of wood molecules (e.g. cellulose) to form covalent oxygen-silicon bonds.

The reactant compound may be an alkoxy group having the formula R—Si(OCH₃)₃ (with the exact structure of the alkoxy part (OCH₃) being subject to any variation which performs the desired function shown in the drawings or its equivalent. Free boron compounds in this formulation are expected to have peak efficiency under 2% since the boron tends to counteract the hydrophobic properties of the silicates when the boron is not bound to the cellulose structure. This is an acceptable range since conventional wood treatment generally utilize 0.5% boron treatments.

Boron may be added as boric acid to the formula effectively in the range of 0.5 to 5%. When added in this form, boron compounds may become trapped in the silicon matrix. Alternatively, a reactive boron reagent of the type discussed previously may be used to from a boron matrix such as that disclosed in FIG. 10, including when used in conjunction with a reactive silicate.

It is preferred that the acid be in very low concentration relative to the silicon donor. If methyl trichloro silane is used as the silicon donor, it is preferred that the solution comprise approximately 0.5% acid. This is significant for many reasons including the limitation of acidity in the end product, the minimization of expensive reactants, the safety of people using the solution, and to minimize toxic emissions.

In one example, that of FIG. 15, the formula is alkyltrialkoxysilane plus alcohol as the carrier plus an acid catalyst plus boric acid as a treatment.

The second example (FIG. 16) might employ the use of B(OCH₃)₃ (trimethyl borane) at any percentage depending on the amount of boron desired. In this example the importance of another acid would be to catalyze the reaction.

The acid catalyst could even be in the range of about 0.01 to 10%. The 10% figure is pushing the reaction as a 10% acid would not affect an environmental change 0.01-4.9% is considered a better range. A base catalyst may also be employed, but is less effectively within the same range. Examples are metal alkoxides [eg. sodium methoxide] ammonia, organic bases [eg. triethylamine].

It has been determined that to drive the reaction without an outside energy source in the embodiments tested that the acid should have a pKa of about 2.5 or less.

Methyltrichlorosilane (MTS) is a compound which in this process functions as an acid catalyst on contact with wood cellulose or moisture within the wood. This could be substituted with other alkyl or aryl silicone halides to generate the acid catalyst in situ in a range of 0.01-10%. It is theorized that this produces hydrochloric acid which will drive the reaction consistent with the limitations set forth hereinabove. In the method shown in FIG. 10, the wood may be exposed to a solution tetrahydrofuran (90%) having 1.0% percent borax as an insect repellant and 9.0% methyltrichlorosilane (Cl₃SiCH₃ or MeCl3Si). As shown in FIG. 10, the MeCl3Si and boron has hydrolyzed to produce MSi(OH)₃ and B(OH)₃ as well as hydrophillic acid as catalyst.

Many other reagents maybe used in addition to or replacing the reagents described in the foregoing description. Although the preceding illustrations utilize boron and silicon, other tetravalent atoms will also work. Other possible reagents include boron oxide (which reacts with water within the wood to generate boric acid), chlorotrimethylsilane, phenyltrimethoxysilane, triphelysilylchloride, propyltrichlorsilane, proplytriethoxysilane, hexamethyldisilanzane, titanium tetrabutoxide, triethylorthosilicate, n-octyltriethoxysilane, octyltriethoxysilane, trimethlborate, triethylborate, bron halides, boric acid, and methyl trichlorosilane. Diatomaceous earth, sodium silicates, or other boron or silicon salts may also be used as a source of donor atoms. These may be mixed to provide intermediaries in solution which would, working together, produce the desired end product. This may include such compounds as boric acid, trimethyl (trialkyl) borate, boron halides (BF₃, BCl₃, etc.), and boric anhydride (boron oxide).

The basic structure of the molecules used in the process described herein include:

R—Xa—Xb₃

or

R3—Xa—Xb

or

R2—Xa—Xb₂

or

R1—Xa—Xb₂

or

R2—Xa—Xb₁

or

R4—Xb

or

R3—Xb

R is a straight chain or branched chain alkyl group, aryl or benzyl group, Xa is a trivalent, tetravalent or pentavalent atom and Xb is a halogen (halogens including fluorine, chlorine, bromine, etc.) atom having valence electron and which may react or their equivalent.

Silicon procatalyst donors might be shown with the general formula R—Si(X₃) This silicon donor can be represented by the general formula where Xb₃ is a halogen such as chlorine, bromine, iodine.

Instead of halogens, Xb could be an alkoxy group (such as methoxy, ethoxy, propoxy, butoxy or an alkoxy group with the number of carbon ranging from 3 to 20 in a straight chain or a branched chain configuration. Larger chains cause interference problems with the reactions). The Xb₃ may also be a phenoxy group, a benzyloxy group or an aryloxy group in which the aromatic ring is replaced with a polycyclic aromatic ring. These would not produce acids

Silicon could be replaced with a group 4 atom such as Ge, Tin or lead. Lead, for example, may be useful in the construction of nuclear plants. While boron and silicon are used in the examples, titanium would work and so would many trivalent, tetravalent, or pentavalent atoms. In other words 3, 4 or 5 valence state atoms (i.e. atoms from groups 3, 4 or 5 of the periodic table) would work in the bonding process. Examples of substitutes for boron include Aluminum, Galium, Indium or thalium (Tl), by way of example.

Similarly, other solvents may also be used in addition to those previously described including acetone, tetrahydrofuran, polydimethylsiloxane, alcohols, and water. It should be noted that the various silicon-boron combinations will work on all wood and treated wood with varying efficiencies and compatibilities. Results vary somewhat based upon the nature of the solvents used and the kind of wood that is treated. For example, acetone based formulas may be optimal for soft wood, whereas the acetonitrile based formulas may work better for hard wood. Likewise, the non-acetone based formula may be preferred for treating Particle Board, OSB, or Chip Board where the glue may be dissolved by acetone. The alcohol based formula may be better for southern pine. Other solvents include any water compatible organic solvents such as dioxain. It is generally preferred, however, that the solvents have a boiling point under 100 degrees Celsius.

Catalysts and other enhancing compounds may also be added to the solution. As described previously, acids and products which yield acids in solution may be used to catalyze the reaction of the previously described reagents and wood cellulose. It should be noted that the reaction of the previously described reagents and wood cellulose is an exothermic reaction. The heat produced from these reactions adds pressure which improves saturation of the treatment. The process may similarly be placed by treating the wood with the proposed solution in an enclosure so that pressure may build. Pressure may also be added to the enclosure to improve saturation.

Other pre-treatment steps may also be used including infusing moisture in the wood before or during treatment. Similarly, solvents may be added to the wood prior to treatment, to help carry the treatment chemicals into the wood. Donors (of boron and silicon, for example) may be infused within the wood prior to the addition of the solvent or acid. This may be particularly useful where wood composites such as fiberboard are manufactured prior to treatment.

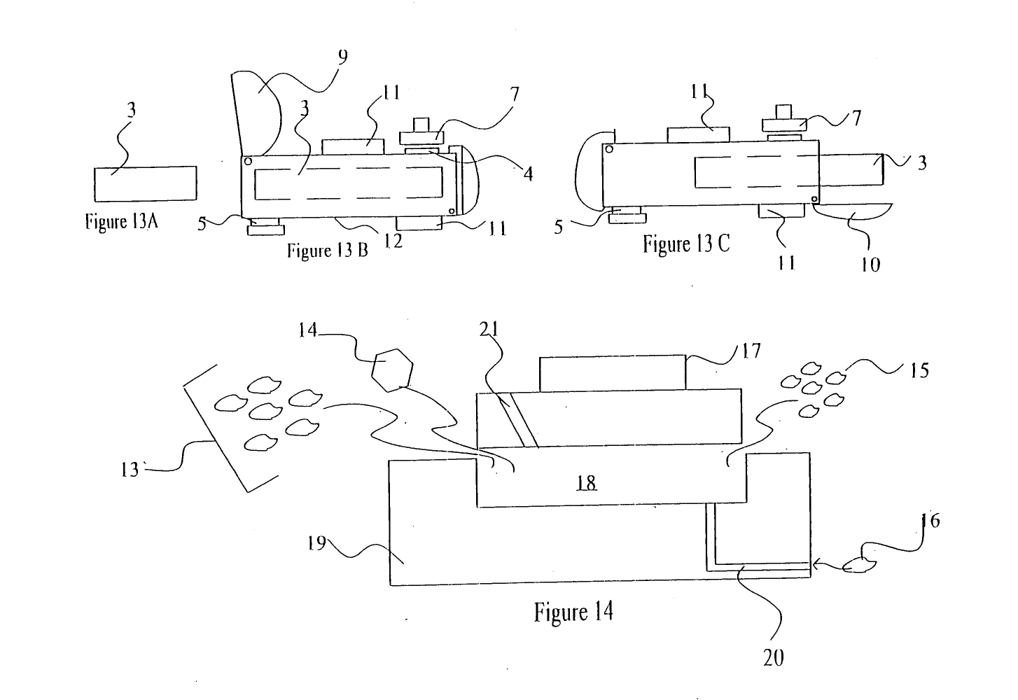

FIGS. 13A, 13B, and 13C illustrated how a chamber may be utilized to treat wood products with the proposed formulation. Wood product 3 is introduced into chamber 12, which opens at entry 9. Once wood product 3 is inserted into chamber 12, entry 9. If desired, an electromagnet field may be introduced to expedite the reaction using field generators 11. Field generators 11 may be magnets or ultrasound generators. In the preferred embodiment, ultrasound is used to align and open passages in the wood to enhance penetration. This field may be maintained throughout the process or it may used at intervals to produce the desired treatment level.

Reactants are introduced through chemical opening 4 in the container which may be sealed by valve 7. A temperature or pressure monitor may be incorporated in the valve or chamber to monitor the progress of the reaction. This allows the user to determine when the reaction is complete or when the reaction has reached a certain level.

The reagents may be drained through a valve in drain 5. Other chemicals such as acid neutralizing agents may then be added to wash or treat the wood. Thereafter, the wood may be removed through entry 9 or exit 10. Entry 9 and exit 10 may be aligned so that one piece of wood may be used to push a treated piece of wood out of chamber 12 in an automated process.

FIG. 14 illustrates how wood particles 13 may be turned into particle board while incorporating the proposed treatment. Wood particles 13 are combined with glue 14 and one of the reagents of the present invention (such as borax) in chamber 18 in bottom 19 of a press. When top 17 of the pump presses on the mixture of glue, wood, and reagent, solvent 16 may be introduced through passage 20 in the chamber to initiate the reaction. Pressure release valve 21 may be used to allow gases and pressure to escape.

Other beneficial properties may be imparted to the end product by utilizing beneficial additives. For example, additives that enhance the desired properties of fire resistance, insect resistance, moisture resistance, adhesion, or insulation may also be added to the wood. In addition, color or stains may be added during the process.

Because Applicant's invention is drawn into the wood, it may be employed on a “green” piece of wood. Applicant's invention, in a departure from earlier technology, is effective on wood and wood products that are not dried or bone dry. The presence of moisture in the wood, or wetness in the wood, provides beneficial effects in the utilization of this invention. The chemical reaction of Applicant's invention is accelerated by the reaction or mixture with the water and other natural liquids inside a piece of wood. The Applicant's invention is drawn into wet wood, participates in reaction and may expulse the excess water and other liquids originally contained within the wood. It can act as a combination treatment and water displacing (i.e. drying by water volume replacement) process in one step. Applicant's invention can be considered for demonstrative purposes as displacing some of the volume of the liquids present in the wood or wood product and replacing that displaces volume with its own. Applicant's invention may drive out fluids of the wood to allow for its own impregnation into the wood and reaction with the wood and wood constituents. If so, the waters may be removed from the solvents as an additional step in order to prevent these from slowing or stopping the reaction.

The applicant's invention is a heat generating, exothermic reaction driven to completion by the products used and the method in which they are introduced into the wood from the hydrophillic organic solvent into the moisture of the wood.

Upon treatment with Applicant's invention, water and other liquids are less able to enter the wood. With the molecular change in the wood's natural liquids and the creation of a protective polymer which may be produced throughout the woods thickness, the wood is naturally and permanently, protected from water; rot; insects; decay, etc.

Tests show that wood treated with Applicant's invention in its preferred embodiment is:
Waterproof,
Decay resistant,
Insect resistant, and
Stronger than before treatment.

Applicant's invention has been able to incorporate all of the benefits attributed to both silicon and boron, individually or in combination, and lock those benefits within the wood. By using the natural liquids of the wood to “pull” or enable transport of the chemical into the wood while allowing the simultaneous reaction of Applicant's reactants with the wood cellulose, Applicant's invention displaces these liquids with the molecules of boron and silicon and creates a polymer “shield” based on the matrix defined by the cellulose polymers to encapsulate or affix a bond to the solids thereby providing protection to the wood.

Hydrophobic elements which prevent the reaction include waters and organic solvents which have a Kow greater than 10. Degrading elements, such as high concentrations of the acids which are generated by the pro-catalysts may be offset by anti-degrading elements such as pH balancing bases or other chemicals able to eliminate the acidity.

Therefore, to carry out a reaction which is commercially viable, the preferred ranges for reactants and non-reactants in the solution applied to wood where a catalyst or pro-catalyst (an acid or an acid producing molecule) is used to drive the reaction could be expressed in the ratios or percentages as set forth below.

(1) The range of acid or procatalyst is in the range of about 0.1-10%. Practically speaking, to protect the wood, this would be from about 0.1 to 4.9%. For purposes of these limitations, the only acids which would work efficiently would be those with a pKa of about 2.5 or less. This would include acids like Hydrochloric and Phosphoric acid as shown in the examples. Pro-catalysts would be those chemicals yielding an acid when exposed to the moisture in the wood or when exposed to the wood hydroxyl groups. Tri-chlorosilane is an example. A lower concentration as low as 0.01% would work slowly; but, since it acts as a catalyst, would still work.

(2) The range of non-catalytic reagent (NCR) would be in the range of 0-65%. Non-catalytic reagent would be reagent which would not react unless in the presence of a pro-catalyst or appropriate acid. Examples of non-catalytic reagents would include hydroxyl and alkoxy bonded to trivalent, pentavalent and tetravalent atoms without halogens bonded to alkyl or aryl groups. The concentration of NCR to pro-catalyst is used to control the cost, acidity and efficiency if the reaction.

From a comparison of the above referenced percentages, it can be seen that the range of acid or pro-catalyst to non-catalytic reagent would be preferably in the range of 1:6 or less (one molecule of pro-catalyst for every molecule of non-catalytic reagent). Preferably the catalyst would be in the range of 5% or less of the non-catalytic reagent. For example, if the catalytic reagent was 50% of the total solution, then the pro-catalyst would preferably be less than 2.5% of the total solution.

(3) The amount of water added to the solution would slow down or degrade the reaction. In order to control this, the practical range would be from 0-0.5%. Using agitation to prevent the formation of oligomers and non-reactive components would allow water concentrations as high as 8.0%. Another useful limitation would be to maintain the water concentration 2.0% below the concentration of the pro-catalyst and NCR.

(4) Similar to water, the concentration on non-hydrophilic organic solvents or even non-organic solvents (such as water) may occur in similar ratios to the solution. Operational ranges for non-hydrophilic organic solvents could range from 0-20%, although a 10% or less range would be more practical.

The use of hydrophilic organic solvents is critical to maintaining reactivity in most situations where this reaction could be run and while a concentration as low as 10% might yield a reaction which could work, a more practical range would be in the range of 99.9%-30% of the total solution. If a competing reaction was present, such as is present where water is used, the solution would have to be 50% more hydrophilic organic solvent then water concentration to remain commercially viable.

Except where used to slow the reaction, the non-hydrophilic organic solvents or non-organic solvents (such as water) would essentially be impurities adding nothing to the beneficial aspects of the reaction except where they could enhance the processes described herein.

5) Since some oligomerization may occur and still allow the reaction to go forward, it is important to view the invention as one wherein there is a solute compound having a functional group which includes (i) an atom selected from the group consisting of trivalent, tetravalent and pentavalent atoms, wherein said atom is bonded to
(A) a halogen atom or
(B) a functional group selected from the group
   consisting of a hydroxyl group, alkoxy group, phenoxy group, benzyloxy group and an aryloxy group having a polycyclic aromatic ring, in the form of a monomer or unstable (transient) oligomer. Since trace amounts of oligomer may occur, the invention can be safely described where the monomer, as a percent of total solution, is over 5%. To be practical, the monomer should be at least 10% of the total solution. This monomer is the reactive component of the solution.

The instant patent technology differs entirely from the prior art technology with respect to the composition in several particulars:

1. Chemical composition of the treatment formula is chemically well defined and identified.

2. The composition does not make use of aqueous solutions. An anhydrous organic solvent is required for the composition.

3. The composition must have a halogenated silane component as a pro-catalyst or a comparable substitute while acids with a Pka of 2.5 or less will work. The effective use of pro-catalyst allows the reaction through the production of acid in the wood. Mixing the acid into the solution prior to putting the chemical into the wood can work, but it is preferably done using lower concentrations with pro-catalysts.

4. The formula or the solute compound is sufficiently small and organized so that it enters wood without prior conditioning and aligns with the wood cellulose without the need for excess energy to disrupt the composition of the solute compound in the wood or during treatment. Wood need only be dipped, brushed or sprayed with the formula to accomplish the desired result.

5. The composition instantly reacts with wood hydroxyl groups on contact and activates the accompanying reagents to form silicon-oxygen covalent bonds not only on the surface but also within the wood, probably forming 7-12 member cyclic silane rings (FIG. 17).

6. Applicant's inventive composition requires no prior drying of wood or no drying of wood after treatment and no curing of wood to be effective.

7. The instant formula are unique with respect to defined and pure ingredients. The formula may employ a halogenated silane (or other pro-catalyst generating the appropriate acid within the wood) or it's equivalent and a non-aqueous organic solvent to be effective.

8. The present formulation also has definite and commercially significant advantages with respect to the use of pure and well defined compositions. The reactants penetrate wood without mechanical assistance (such as application of vacuum, or heat pressure). Stable silicon and boron bonds to wood that are not leached out are formed in a simple treatment. Non-water based formulations are used. Water is not recommended in the compositions and a non-aqueous organic carrier is used. A halogenated silicon [eg. Methyltrichlorosilane] is used as the reactive reagent (pro-catalyst). The reaction of methyltrichlorosilane to wood hydroxyl groups forms spontaneous permanent bonds wood . It must be noted that only after this initial spontaneous reaction of MTS with water and wood cellulose and the generation of HCl, are the remaining reagents in the formula activated for reaction with wood hydroxyl groups. A spontaneous reaction with wood hydroxyl groups and release of reactive agents (HCl) within the wood activates the non-pro-catalyst reactants to further react with wood cellulose to create new silicon (boron) bonding to wood.

The present invention avoids the need for energy application by applying reactive solutes to the wood itself and creating any polymers or any oligomers in the wood as part of an exothermic reaction generating the energy with which to carry the reaction to the point of creating a polymer out of the cellulose.

The present invention includes the use of un-oxygenated silane chemicals which are applied to the wood and, utilizing a catalyst in the form of acid or a reacted solute such as a halogenated compound such as methyltrichlorosilane that in the wood cellulose matrix are reacted in order to get the intermediary oxygenated silane which then immediately react with the hydroxyl groups in the cellulose in order to polymerize the oxygen and silicon atoms in order to form chains directly on the wood cellulose catalyzed by the acid formed by water in the wood and the halogen. The dramatic and non-obvious result is that instead of having to utilize energy in order to generate the reaction, the reaction itself is self-propagating and will generate heat and pressure until the entire wood is treated or until the silane reagent is used up forming a protective barrier on every side of the wood cellulose chains.

An added benefit is, instead of requiring that the oxygenated solute be pushed into the wood under pressure, leading to imperfect saturation and high cost, the reaction pulls in the unoxygenated silane as fuel for the chemical reaction so that penetration may be obtained at a much deeper level.

One reason for using organic solvents is in order to prevent the oxygenation of the silane until they come in contact with the water within the wood. One limitation would be to have at least 50% unoxygenated silane to prevent waste.

Methyltrichlorosilane is not the predominant reagent in the most effective embodiments, but is an activator used in catalytic amounts to initiate the reaction of a nonactivators such as methyltrimethoxysilane which is the primary reagent that forms the vast majority of covalent linkage to wood molecules having hydroxyl groups [cellulose, lignin etc].

The solvents, in the preferred embodiment, are non-reactive hydrophilic solvents to allow penetration of reactive reagents [a mixture of methyltrichlorosilane and trimethyl borate, for example] and non-reactive alkoxy silanes to deep within or interior of both wet and dry wood.

A plurality of Applicant's reactive molecules may enter to the wood cellulose from a solution as shown in FIG. 17A. Here the solution is an alcohol 72 solvated solution, although there may be trace amounts of water 71 and other organic solvents 70. A pro-catalyst 27 (MeSiCl3 here) and a silicone donor 73 (MeSi(OCH3)3 here) are used to prevent the pro-catalyst 27 from adding too much acidity to the wood. The use of hydrophillic organic solvents and monomers allows the reaction to begin and proceed by simple diffusion of the solvents and reactants into the wood.

One of the pro-catalyst monomers 30 has reacted with water in the wood to form the catalytic acid 65 (HCl) as also shown in FIG. 7.

FIG. 17b shows where the acid 65 is catalyzing the reaction with a non-pro-catalyst silicone donor 73.

Next, this process continues so that a plurality of reactive molecules are chemically linked to at least one second reactive molecule so as to form a matrix of cross linked reactive molecules one reactive molecule linked to the wood as shown in FIG. 18C and also linked to at least one other reactive molecule linked to the wood FIG. 17d to form a cross linking of reactive molecules and wood FIG. 17d. Within or between these modified cellulose chains, borates 42 and other additives may be trapped as shown in FIG. 17e.

The result is a plurality of reactive molecules having a link to the wood cellulose and wherein at least one first reactive molecule is chemically linked to at least one second reactive molecule so as to cross-link the plurality of reactive molecules to the wood cellulose through one or more of the hydroxyl groups on the wood cellulose. The compounds are covalently bonded through reaction with one or more hydroxyl groups of the wood cellulose.

At least one first reactive molecule is chemically linked to at least one second reactive molecule so as to cross-link the plurality of reactive molecules to the wood cellulose through one or more of the hydroxyl groups on the wood cellulose.

The solution contains a hydrophilic organic solvent and a plurality of molecules having at least one first molecule and at least one second molecule selected from R—Xa—Xb₃, R₃—Xa—Xb, R2 Xa Xb₂, R2 Xa Xb, R4Xa, R3Xa or R Xa Xb₂, wherein R is an alkyl group, Xa is a trivalent, tetravalent or pentavalent atom, and Xb is a halogen, hydroxyl group, an alkoxy group, a phenoxy group, a benzyloxy group or an aryloxy group with a polycyclic aromatic ring. The process involves applying the solution to wood cellulose and exothermically reacting said plurality of molecules with the wood cellulose so the first molecule is covalently bonded to the wood cellulose, and repeating the steps over the matrix defined by the cellulose matrix to have a polymer shield of repeating rings (FIG. 17D).

The process for the polymerization of wood cellulose, has the steps of:

(a) providing a solution containing a hydrophilic organic solvent and a compound containing a trivalent, tetravalent or pentavalent atom and a halogen atom, hydroxyl group, alkoxy group, phnoxy group, benzyloxy group or an aryloxy group having polycyclic aromatic ring (a polymer of a plurality of atoms containing a trivalent, tetravalent or pentavalent atom and a halogen atom, hydroxyl group, alkoxy group, phnoxy group, benzyloxy group or an aryloxy group having polycyclic aromatic ring might work poorly if it was disrupted (essentially rendering it into the compounds previously set out) before being introduced in the wood or afterwards because of the need to align molecules);

(b) applying said solution to wood cellulose in the presence of a catalytic compound as defined herein and,

(c) exothermically reacting said compound with the wood cellulose so that the compound is covalently bonded to the wood cellulose.

Boron Oxide, reacts with moisture/water within the wood or wood products to generate Boric Acid that could be entrapped with the silicon shield. However, in the proportions stated, trimethylborate [TMB] reacts with water/moisture within wood to undergo partial or full hydrolysis to polyborates or boric acid respectively (FIGS. 8 & 9). It could after partial hydrolysis react with methyltrihydroxysilane to form mixed boron-silicon polymers [FIG. 10] and with the proper catalysts triethylborate and other alkylborates could be incorporated into wood in this manner.

A 0.5% solution of boric acid in acetone with an appropriate amount of TMB can be used for a more stable formulation with a silicon donor such as MTS.

Boron Halides, borontrichloride, borontribromide and borontrifluoride are examples of highly reactive compounds which will directly react with the hydroxyl groups of wood cellulose or other compounds of wood to form respective borates with the elimination of acid halides and can act as procatalysts which do not react directly.

FIG. 7 shows the hydrolysis of MTS to methyltrihydroxysilane within the wood and its subsequent conversion to a polysiloxane that reacts with the hydroxyl groups of wood cellulose forming the polymer shield in the presence of the catalyst created in the wood (HCl) who MTS is used.

The main concern with the use of this reagent is the inevitable hydrochloric acid release. This problem can be addressed in various ways, one being to exposure of the treated wood to neutralizing solutions. The other method taught herein would minimize the ratio of procatalyst to non-reactive alkyl hydroxy trivalent, pentavalent or tetravalent atom.

Silicon donors in one embodiment have the general formula R—Si(X)₃. This silicon donor can be represented by the general formula R—Si(X)₃; where X is a halogen such as chlorine, bromine, iodine or an alkoxy group (selected from methoxy, ethoxy, propoxy, butoxy or an alkoxy group with the number of carbon ranging from 3-20 in a straight chain or a branched chain configuration); or a phenoxy group, a benzyloxy group or a benzyloxy group in which the benzene ring is replaced with a polycyclic aromatic ring. In the preferred embodiment X is part procatalyst (halogens) and part non-catalysts (alkoxyls).

The R group in the above silicon donor is an alkyl group ranging in a carbon chain length of 1-20 units in a straight chain or branched chain configuration. All these reagents are capable of undergoing the similar transformation as depicted in FIG. 7. While halogen substituted reagents are very reactive and the reaction could be completed within a few hours. The non-halogen substituted silicon reagents with this general formula react only slowly (if at all) without a procatalyst and the completion of the reaction would require days under ordinary conditions. However this process is enhanced by the inclusion of acid or base catalysts to the silicon reagents. These catalysts include, but are not limited to, a metal alkoxide or an acid such as meta-phosphoric acid.

In the above general formula Silicon (Si) can be substituted with Titanium (Ti) or other tetravalent atoms and other factors remain the same. A typical example would be Tetramethyltitanate. A general representation of the formula would be Ti[R]₄ where R=a halogen, an alkoxy group, a phenoxy group or a benzyloxy group as defined above for the silicon donor.

The following silicon reagents can also react with the hydroxyl groups of wood components to render wood hydrophobic, insect and fire resistant:

(1) Dichlorodimethylsilane represented by the general formula: [R]₂Si(X)₂; where R is an alkyl group ranging in carbon chain length of 1-20 units as a straight chain or as a branched chain, or a phenyl group or a benzyl group and X is a halogen, an alkoxy, aryloxy or benzyloxy as defined above. Another common example is dichlorodiphenyl-silane.

(2) Chlorotrimethylsilane represented by the general formula [R]₃Si—X, where R is the same selected from the above and X is the same selected from the above. Another common example is Chlorotriphenylsilane.

(3) Hexamethydisilazane: This compound will form a trimethylsilyl derivative of the hydroxyl groups of the components of wood or wood products with the evolution of nitrogen in combination with an appropriate catalyst. The catalyst may be phosphoric acid that by itself may render the wood fire resistant.

(4) Octyltriethoxysilane [OTS]. Is an excellent reagent that would function in a neutral environment. The drawback its high boiling point [difficulty drying] and slow reaction (more than a week after treatment). A waiting period of at least one month might be required to complete the process. The reagent is cost-effective and environmentally clean. Possible improvements to speed up the reaction with the addition of catalysts [metaphosphoric acid or other acid catalyst] that could also provide fire proofing. Another common example is Propyltriethoxysilane.

Phosphorous reagents can also be used to derivatize (modify) the hydroxyl groups of wood components to make the wood fire and insect resistant. Common reagents that can be used for this purpose are:

(1) Triethylphosphate: Here phosphorous is in the pentavalent state and the trimethoxy groups are prone to hydrolysis by moisture/water within the wood and generate phosphoric acid or polyphosphoric acid which is a fire retardant. The hydroxyl groups of the cellulose or other wood components may directly react with triethylphosphate displacing one or more of the methoxy groups with the formation of a chemical bond between the phosphorous and the oxygen atoms of one or more of the hydroxyl groups. Another common example is trimethylphosphate.

(2) Triethylphosphite: Here phosphorous is in the trivalent state as in trimethylborate [TMB] and the mechanism of reaction with wood or wood components are identical to those of TMB as described above. As is the case with TMB there are two possibilities. Triethylphosphite can react with moisture/water in the wood or wood components to produce phosphoric acid or polyphosphoric acid within the wood to make it fire and insect resistant which when used in combination with a silicone reagent would trap the phosphoric acid inside. Alternately triethylphosphite can react with one or more hydroxyl groups of wood cellulose or other components of wood to form permanent chemical bonds to render wood fire and insect resistant. Other common reagents are trimethylphosphite or triphenylphosphite. Specific formulations include:
1. A composition consisting of a mixture of a pro-catalyst preferably methyltrichlorosilane in the range from 0.25% to 4.0%; a silicon additive, preferably methyltrimethoxysilane in the range of about 1.5 to 40%, a boron additive, preferably trimethylborate, in an organic drying solvent, preferably ethyl alcohol, to treat all wood and wood products to render to wood and wood products simultaneous hydrophobicity, microbial resistance and fire retardency. Using a kow as a standard, the solvent's kow could be a kow less than zero. The preferred solvents generally have a kow of −0.15 or less. Less than 2.0 could work in limited circumstances. A kow over 10 would be impractical. This general relationship of kow would apply to all solvents.

The K_{ow}, or Octonal Water partition coefficient, is simply a measure of the hydrophobicity (water repulsing) of an organic compound. The more hydrophobic a compound, the less soluable it is.

While Kow is a standard for differentiation purposes, different organic solvents can work with different Kow. Hence, the better range is a log(K_{ow}) less than 1.0 or even one less than zero. However, Kow alone does not define the reactants since water has a Kow of 1. Also mixtures of solvents may work, even those containing water, as long as the overall solvent allow for the function described herein, namely allowing the reactants to be drawn from the solution into the wood at a desired rate of speed and without oligomerization in the solvent.
2. A composition for treatment of all wood and wood products, as set forth above consisting of a mixture of a pro-catalyst in the range of 0.25 to 4% represented by the formula R—X(Y)₃ where R is selected from a group of straight or branch chain alkyl substituents ranging in carbon numbers from 2-18 (eg. Methyl, ethyl, propyl, isopropyl, butyl, isobutyl, tertiary butyl, pentyl, isopentyl etc.), and aryl substituents phenyl and benzyl; X is an atom selected from the group Si, Ge, Sn, PB, TI, Zn and Y is selected from a group consisting of Chlorine, Bromine, Iodine and Flourine; and a silicon additive in the range of about 3.0 to 40%, represented by the formula R—X(Y)₃, where R and X represents the same groups as above for the silicon non-catalyst, but Y is selected from a group consisting of methoxy, ethoxy, propoxy, butoxy, t-butoxy, pentoxy, isopentoxy, hexyloxy, phenoxy and benzyloxy substituents in an organic drying solvent selected from a group consisting of methanol, ethanol, propanol, isopropanol, n-butanol, isobutanol, tertiary butanol, pentanol, isopentanol, benzyl alcohol, acetone, tetrahydrofuran, dioxane and acetonitile to render wood and wood products simultaneously hydrophobic, microbial resistant and fire retardant.
3. A composition for the treatment of all wood and wood products consisting of a mixture of a pro-catalyst according to paragraph 1, as it is defined above; a silicon additive as defined and trimethyborate [B(OMe)₃] in the range of about 0.25 to 35% in an organic drying solvent as defined, to render to the wood hydrophobic, and microbial resistance and fire retardant simultaneously.
4. A composition for the treatment of all wood and wood products, consisting of a mixture of reactive silicon reagent, a silicon additive and another reactive reagent in which trimethyborate is replaced with a compound having the general formula X(R)₃, where X is selected from a group of atoms consisting of B, Al, Ga, In, Tl, P, As, Sb, Bi and V and R is selected from a group consisting of F, Cl, Br, I, methoxy, ethoxy, propoxy, isoporpoxy, isobutoxy, pentoxy, isopentoxy, butoxy, tertiarybutoxy, phenoxy and benzyloxy substituents to render to wood and wood products hydrophobicity, microbial resistance and fire retardancy.

One embodiment of Applicant's invention is a solution as shown in Example 1:

### EXAMPLE-1

### Preparation of Reagents for Wood Treatments

### Basic Silicon Formula (FRF-S): [Silicon]

In a 250 mL reagent bottle was added 137 mL of reagent alcohol was added followed by 60 mL of methyltrimethoxysilane (MTMS). After mixing the two agents by shaking; 3.0 mL of methyltrichlorosilane (MTS) was added from a pipette to this solution and kept ready for treatment. This clear colorless formula was found to be stable for the next several months with no appearance of any residue or cloudiness.

The drying agent is denatured alcohol available as a gasoline additive. This could be substituted with wood alcohol which is commercially available as an industrial solvent. The formula is made of 30% methyltrimethoxysilane (MTMS) and 1.5% methyltrichlorosilane (MTS).

### Basic Boron-Silicon Formula (FRF-BS): [Boron, Silicon]

This formula is made of 30% methyltrimethoxysilane; 3% trimethyborate and 1.5% methytrichlorosilane (MTS) in denatured alcohol. This boron and silicon containing treatment formula was prepared as above except, 131 mL of alcohol, 60.0 mL of MTMS, 6.0 mL of trimethylborate and 3.0 mL of MTS was used. The reagent was found to be stable without decomposition, residue formation or color change for the next several months of observation.

### Modified Boron-Silicon Formula (FRF-MBS) [Modified Boron, Silicon]

This formula is made as a substitute for FRF-BS. The formula consists of 30% methyltrimethoxysilane (MTMS); 2% boric acid and 1.5% methyltrichlorosilane (MTS) in denatured alcohol. The formula consisted of 137 mL of denatured alcohol, 60 mL of MTMS, 3.0 mL of MTS and 4.0 grams of boric acid. On shaking this mixture for 10 minutes complete dissolution of the boric acid occurred and a crystal clear colorless solution was obtained which was also stable for the next several months of observation.

### EXAMPLE-2

### Treatment of Wood

In a closed bell jar 200 mL of the appropriate reagents, (FRF-S; FRF-BS and FRF-MBS formula prepared as specified above) were poured and three wood pieces were placed inside such that about three fourth portions of the wood blocks were immersed in the reagents. 1×1″ blocks of red oak and yellow pine as supplied (raw wood) were used for this study. The wood pieces were allowed to remain in this jar overnight during which time the reagents were drawn inside the wood. The temperature of the reagent solution increased by about 5 degree Centigrade during the initial exposure time of about 20 minutes by which time the penetration of the formula to the top surface of the wood was complete.

The wood pieces were allowed to air dry and periodically they were weighed to constant weight gain (about 48 hours). From this the incorporation of reagents to wood was calculated on a weight basis. The results are tabulated in the following table.

| Wood Sample | Wood Dimension | % Weight Gain | % Si | % B |
|---|---|---|---|---|
| Red Oak | 1 × 1″ | 5.48 [FRF-S] | 5.48 | 0.0 |
| Red Oak | 1 × 1″ | 5.85 [FRF-BS] | 5.32 | 0.53 |
| Red Oak | 1 × 1″ | 3.13 [FRF-MBS] | 2.98 | 0.25 |
| Yellow Pine | 1 × 1″ | 9.6 [FRF-S] | 9.60 | 0.0 |
| Yellow Pine | 1 × 1″ | 9.1 [FRF-BS] | 8.19 | 0.91 |
| Yellow Pine | 1 × 1″ | 8.68 [FRF-MBS] | 8.10 | 0.58 |

The above results show that red oak, a hard wood incorporates less reagents compared to soft wood (yellow pine) under identical treatment conditions. Although the desired levels of boron and silicon incorporation was achieved by this process, additional experimentation would be needed to see whether increasing the treatment time would increase reagent incorporations to the samples if desired.

The results are averages of three independent determinations.

### EXAMPLE-3

### Hydrophobicity

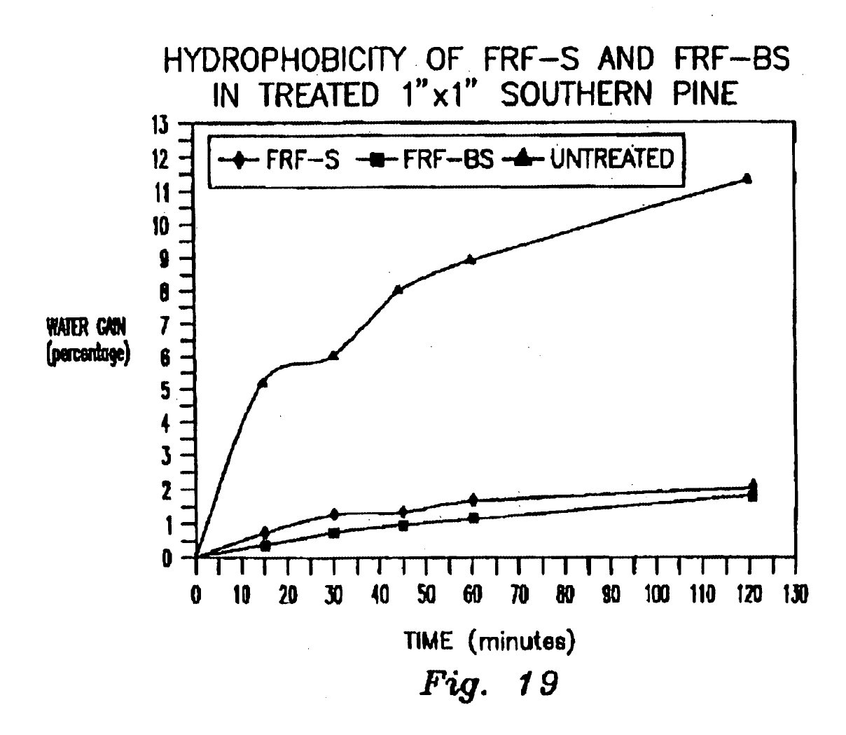

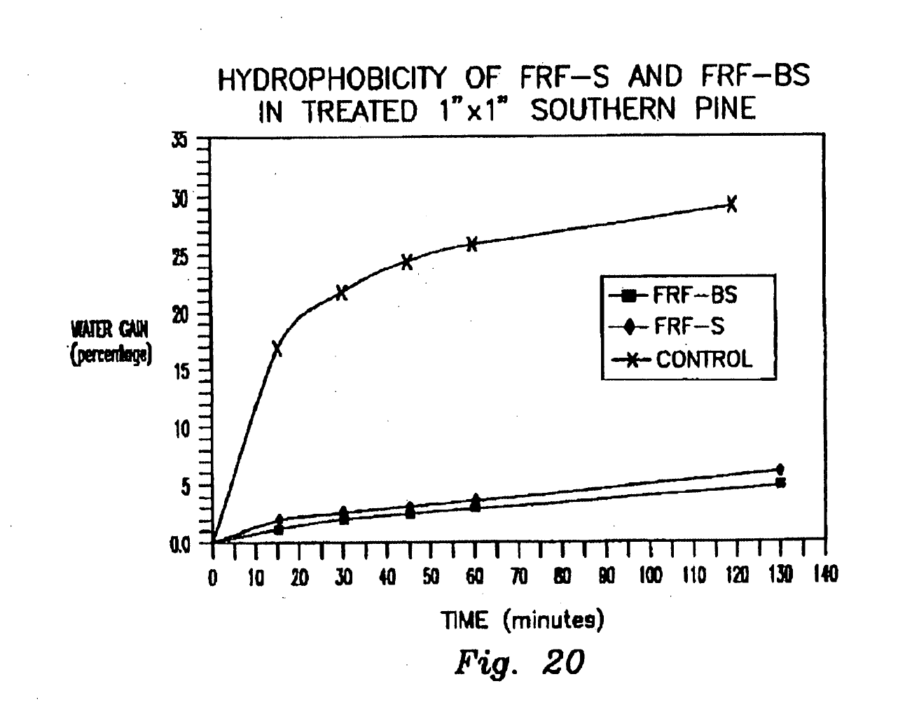

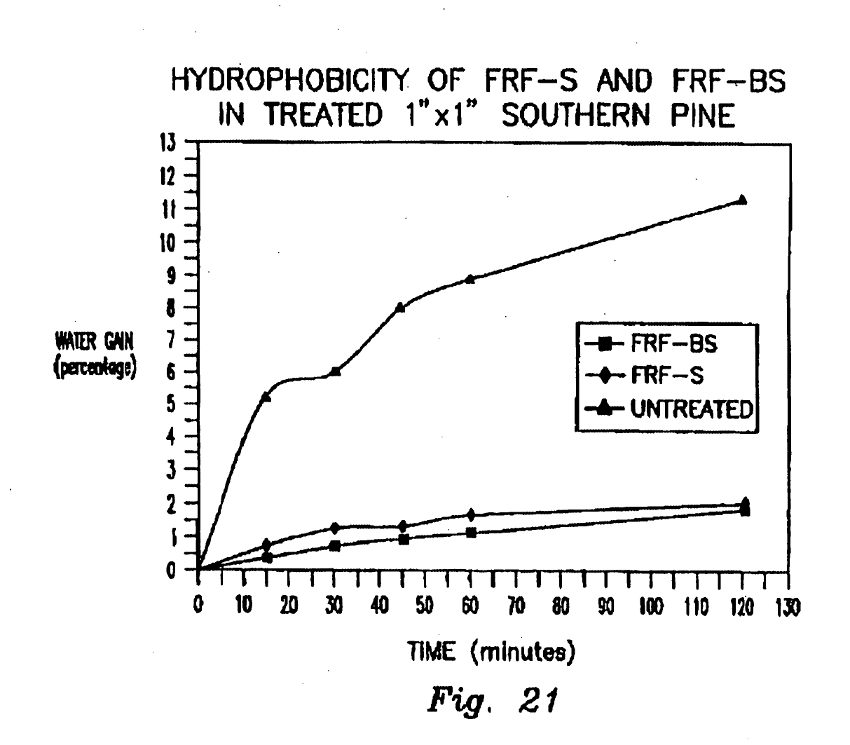

Pieces of red oak and yellow pine treated as above in example-2 and untreated wood (red oak and yellow pine) blocks were selected at random and they were completely immersed in water (distilled water, immersions accomplished by placing a glass stopper over the wood piece such that the entire wood is completely immersed in water) for varying periods of time, and the weight of water absorbed as a function of time was determined for each treatment. These comparative results obtained under identical conditions are summarized in the accompanying graphs providing in FIGS. 18-21. The results clearly illustrates that there are striking differences in the water absorption of treated wood with the untreated control.

The results show that the apparent water absorption for red oak and yellow pine are similar although their silicon and boron contents differ significantly. Similarly FRF-S treated wood samples and FRF-BS treated wood samples exhibit similar hydrophobicity indicating that boron incorporation is not adversely affecting hydrophobicity of treated wood samples. These results indicate that boron is trapped in a silicate-cellulose matrix and water is precluded from coming in contact with boron due to the silicon shield.

The difference between treated wood and untreated wood in terms of water absorption at different time intervals was phenomenal. FIGS. 18-21 shows the results with southern pine, a soft wood that has not been conditioned. At 30 minutes the untreated wood absorbed more than 20% of water while treated wood with both formulae had less than 2% water absorption. A comparison of water absorption at 30 minutes with that of 60 minutes for both samples indicate that further water absorption was less than 1.0% indicating that water is occluded initially on surface but not absorbed significantly as a function of time. In one hour untreated Southern pine of the same dimension and weight absorbed a remarkable 30% of water. Similar results were obtained with red oak that absorbed less water than southern pine as expected.

It should be noted that there has been complete immersion of wood within water for the entire indicated periods as opposed to floating the wood in water for 15 minutes or exposing wood under running water for a few minutes to evaluate water absorption by other investigators in the cited up on prior art.

### EXAMPLE-4

### Retention

The water solution remaining after immersion of the respective treated samples for 24 hours performed as in Example-3 was transferred to a previously weighed beaker. First the FRF-S treated sample was examined. The solution was allowed to evaporate at room temperature. No residue was left in the beaker after complete evaporation. The beaker was weighed again. The results showed that there was no significant difference in the weight of the beaker before and after evaporation. The results showed that no silicon was leached out from the FRF-S treated wood pieces and the silicon is irreversibly bound to the wood molecules.

The FRF-BS treated sample and the FRF-MBS treated samples were similarly immersed and evaporation of the water showed minute residues, but the weights differences were insignificant indicating that both boron and silicon were retained within the wood without significant leaching out in complete agreement with expectations.

The wood pieces after leaching with water for 24 hours as above were weighed to constant weight. Twelve to twenty four (12-24) hours after the leaching experiment was performed the wood pieces returned to their initial weight. This experiment adduces further independent evidence that no incorporated reagents (boron and silicon) were leached out of the wood during prolonged immersion of treated wood in water. During the remaining one month a weight of loss of less than 0.5% was observed further substantiating that boron and silicon were not leaching from wood treated with the inventive formulae.

Except as otherwise provided in the foregoing description, all percentages are expressed in terms of volume percentages.

The preceding description contains significant detail regarding the novel aspects of the present invention. It is should not be construed, however, as limiting the scope of the invention but rather as providing illustrations of the preferred embodiments of the invention. Thus, the scope of the invention should be fixed by the following claims, rather than by the examples given.

Having described my invention, I claim:

1. A process for treating wood having wood cellulose having a plurality of hydroxyl groups comprising the steps of:
a. providing a solution having
i. a solute compound having a plurality of functional groups wherein each of said plurality of functional groups includes a tetravalent atom, wherein said tetravalent atom is bonded to a halogen atom or a functional group selected from the group consisting of a hydroxyl group, alkoxy group, phenoxy group, benzyloxy group, an aryloxy group having a polycyclic aromatic ring, and combinations thereof;
ii. at least one catalyst selected from a group consisting of an acid catalyst, a pro-catalyst configured to yield an acid in the presence of said wood cellulose or water in said wood cellulose, and combinations thereof;
b. applying said solution to said wood cellulose along with an organic solvent thereby allowing said solute compound to be drawn from said solution into said wood by an acid generating reaction within said wood; and
c. reacting said functional groups to form covalent bonds with other functional groups of said solute and to said wood cellulose after the application of said solution to said wood.

2. The process according to claim 1, further comprising the step of reacting said solute compound functional groups only upon contact with the wood cellulose or water in wood cellulose.

3. The process according to claim 2, further comprising the steps of simultaneous reaction and diffusion of the functional groups in the wood and an exothermic reaction of said functional groups upon application to the wood to form covalent bonds with other functional groups of said solute and to said wood cellulose.

4. The process of claim 3, wherein said catalyst comprises a substance which reacts with water in the wood to generate acid in a heat generating reaction so that the functional groups bond from the tetravalent atom across an oxygen of the cellulose hydroxyl group.

5. The process of claim 1, wherein said catalyst is in the range of 0.05-10% volume of the solution.

6. The process of claim 5, wherein said catalyst is in the range of 0.05-4.9% volume of the solution.

7. The process of claim 1 wherein said catalyst is a strong acid.

8. The process of claim 1, wherein said catalyst is in the range of 0.01-10% weight in situ the wood.

9. The process of claim 1, wherein said catalyst is a molecule comprised of silicon and a halogen.

10. The process of claim 1 wherein the solution is less than 20% volume oligomers of the functional groups prior to applying the solution to the wood.

11. The process of claim 1 further comprising the step of adding at least one non-reactive additive to the wood cellulose that enhances a desired property selected from the group consisting of:
a. fire resistance,
b. insect resistance,
c. moisture resistance,
d. color,
e. adhesion,
f. insulation, and
g. combinations thereof.

12. The process of claim 11, wherein the step of adding at least one non-reactive additive further comprises adding the additive to the solution.

13. The process of claim 11, wherein the step of adding the at least one non-reactive additive occurs before reacting the functional groups to bond with the wood cellulose.

14. The process of claim 11, wherein the additive is from the group consisting of:
a. diatomaceous earth,
b. sodium silicates,
c. boron salts,
d. boric acid,
e. trimethy borate,
f. Boron Halides,
g. Boric Anhydride,
h. phosphorous compounds,
i. copper compounds,
j. metal alkoxide,
k. meta-phosphoric acid,
l. phosphoric acid,
m. metaphoshoric acid,
n. silicone salts,
o. trialkyl borate,
p. boron oxide, and
q. combinations thereof.

15. The process according to claim 1, wherein the wood cellulose has an original weight and wherein the duration of treatment attains a weight of compound which is covalently bonded to the wood cellulose having a range of 0.1 to 10 weight percent of the original weight of the wood cellulose.

16. The process of claim 7, wherein said catalyst has a pKa below 2.5.

17. The process of claim 1, wherein said organic solvent has a (K_{ow}) less than 10.0.

18. The process of claim 17, wherein said organic solvent has a (K_{ow}) less than 1.0.

19. The process of claim 18, wherein said organic solvent has a (K_{ow}) less than 0.

20. A process for treating wood cellulose having a plurality of hydroxyl groups comprising the steps of:
a. providing a solution having
i. a solute compound having a plurality of functional groups wherein each of said plurality of functional groups includes a tetravalent atom, wherein said tetravalent atom is bonded to a halogen atom or a functional group selected from the group consisting of a hydroxyl group, alkoxy group, phenoxy group, benzyloxy group, an aryloxy group having a polycyclic aromatic ring, and combinations thereof;
ii. at least one catalyst selected from a group consisting of an acid catalyst, a pro-catalyst configured to yield an acid in the presence of said wood cellulose or water in said wood cellulose, and combinations thereof;
b. applying said solution to said wood cellulose and; and
c. reacting said functional groups of said solute to form covalent bonds with other functional groups of said solute and to said wood cellulose after the application of said solution to said wood cellulose.
